(19) United States
(12) Patent Application Publication
(10) Pub. No.: US 2015/0215668 A1
(43) Pub. Date: Jul. 30, 2015

(54) Method and System for cross-device targeting of users

(71) Applicant: Silveredge, Inc., Redmond, WA (US)

(72) Inventor: Hitesh Chawla, San Francisco, CA (US)

(21) Appl. No.: 14/606,227

(22) Filed: Jan. 27, 2015

Related U.S. Application Data
(60) Provisional application No. 61/932,797, filed on Jan. 29, 2014.

(51) Int. Cl. H04N 21/439; H04H 60/33; H04N 5/60; G06Q 30/02; H04N 21/45; H04N 21/442; H04N 21/258; H04N 21/234; H04H 60/58; H04N 21/81

(52) U.S. Cl. CPC H04N 21/4394; H04H 60/58; H04H 60/33; H04N 5/60; H04N 21/812; H04N 21/4532; H04N 21/44222; H04N 21/25891; H04N 21/23424; G06Q 30/0255

(57) ABSTRACT

A method and system is provided for retargeting a user across multiple devices. The method includes broadcasting a media mixed with an audio data stream to one or more electronic devices, where the audio data stream contains an identifier. Further, the method includes receiving the audio data stream on at least one communication device. The method further includes deciphering the identifier from the audio data stream. The method further includes receiving the identifier & device data at a server, where the device data includes device information of the at least one communication device. Finally, the method includes sending one or more messages to the at least one communication device, where the one or more messages is related to the identifier.

### CROSS REFERENCE TO RELATED APPLICATIONS

This application claims the priority benefit of U.S. provisional application 61/932,797, “Method and System for cross-device targeting of users”, filed Jan. 29, 2014, inventor Hitesh Chawla; the entire contents of which are incorporated herein by reference.

### BACKGROUND OF THE INVENTION

1. Field of the Invention

The present invention relates to user tracking in general. More specifically, the present invention relates to a method and system for cross-device targeting of users.

2. Description of the Related Art

Every year, billions of dollars are spent on advertising across different electronic mediums like TV, Internet, mobile and radio. So basically, so much money is spent on different mediums, without having any knowledge about user's interactions across these multiple mediums. This is an inefficient market for a marketer, as the money is being spent on each medium as if each medium targets separate set of users.

Further, marketers achieve good ROI on their marketing spend by retargeting users. Retargeting is a form of advertising where a user is shown ad advertisement of a product which the user browsed previously. This is easy to achieve by dropping a cookie on a laptop of the user when he is browsing the product. But it is not easy to retarget a user when is accessing a different device, as the cooking was dropped on this laptop.

In the light of the foregoing discussion, there is a need for a system which can unify the interaction of the users across the multiple devices. And based on their unified interactions, retarget those users with relevant advertisements, to make the advertising more relevant and cost-effective.

### BRIEF SUMMARY OF THE INVENTION

Accordingly, it is an object of the present invention to provide a method and system for identifying users across multiple devices.

Further, it is an object of the present invention to provide a method and system for retargeting users across multiple devices.

The above and other objects of the present invention are achieved by providing a method and system for retargeting a user across multiple devices. The method includes broadcasting a media mixed with an audio data stream to one or more electronic devices, where the audio data stream contains an identifier. Further, the method includes receiving the audio data stream on at least one communication device. The method further includes deciphering the identifier from the audio data stream. The method further includes receiving the identifier & device data at a server, where the device data includes device information of the at least one communication device. Finally, the method includes sending one or more messages to the at least one communication device, where the one or more messages is related to the identifier.

### BRIEF DESCRIPTION OF THE DRAWINGS

For a more complete understanding of the present invention, the needs satisfied thereby, and the objects, features, and advantages thereof, reference now is made to the following description taken in connection with the accompanying drawings.

FIG. 1 shows a block diagram of a system for cross-device targeting of users, in accordance with an embodiment of the present invention.

FIG. 2 shows a flow chart of a method for cross-device targeting of users, in accordance with an embodiment of the present invention.

FIG. 3 shows a method for the implementation of the present invention, in accordance with an embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention

### DETAILED DESCRIPTION OF THE INVENTION

Before describing in detail the particular method and system for cross-device targeting of users, in accordance with an embodiment of the present invention, it should be observed that the present invention resides primarily in combinations of method and system components related to computing device of the present invention.

Accordingly, the system components have been represented where appropriate by conventional symbols in the drawings, showing only those specific details that are pertinent to understanding the present invention so as not to obscure the disclosure with details that will be readily apparent to those of ordinary skill in the art having the benefit of the description herein.

In this document, relational terms such as ‘first’ and ‘second’, and the like may be used solely to distinguish one entity or action from another entity or action without necessarily requiring or implying any actual such relationship or order between such entities or actions. The terms ‘comprises’, ‘comprising’, or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by ‘comprises . . . a ’ does not, without more constraints, preclude the existence of additional identical elements in the process, method, article, or apparatus that comprises the element.

The terms “mobile device” and “communication device” have been used interchangeably, and refer to computing device which has the capability of communicating or interacting with its users.

The method for identifying and retargeting a user across devices includes adding an identifier to a media. In an embodiment of the present invention, the method includes mixing an audio data stream with a media to be broadcast, the audio data stream containing an identifier. The identifier can be for one of an advertiser, the media to be broadcast and a marketing message to be delivered. The media can be one of a TV show, a radio program, a video advertisement, a radio advertisement and a media file. Then, the method includes broadcasting the media on one or more electronic devices, the media including the audio data stream. Examples of the one or more electronic devices include television, radio, computer, laptop, mobile phone, PDA and the like

The method further includes receiving the audio data stream on at least one communication device. The at least one communication device receives the audio data stream by extracting the data stream from the media. Examples of the at least one communication device include, but are not limited to, mobile phone, tablet and personal computer. The audio stream is received by an application installed on the at least one communication device, by accessing the microphone of the at least one communication device. The application can be running in the foreground or in the background.

The method includes then associating the identifier in the audio data stream with the at least one communication device. For example, it is assumed that a user listening to an advertisement on Radio is interested in the product in the advertisement. So that intent data of the user is associated to his mobile phone, which receives the audio data stream of the advertisement.

Finally, the method includes sending one or more messages to the at least one communication device, where the one or more messages are related to the identifier. The one or more messages can be sent via push notifications, banner advertisements or native advertisements. For example, the advertisement can be for a product that a user listened about on TV or Radio.

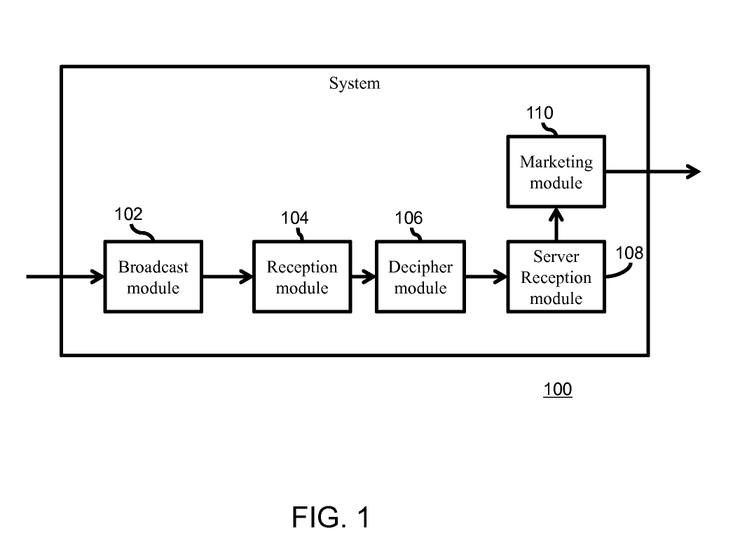

FIG. 1 shows a block diagram of a system 100 for cross-device targeting of users, in accordance with an embodiment of the present invention. The system 100 includes a broadcast module 102, a reception module 104, a decipher module 106, a server reception module 108 and a marketing module 110. The broadcast module 102 broadcasts a media mixed with an audio data stream to one or more electronic devices, where the audio data stream contains an identifier. In an embodiment, the media is in one of audio format and audio-video format. The media can be broadcasted by one of satellite, direct to home, Internet, IP, cinema and radio. Further, the media can also be broadcasted locally via stored media, like CD, DVD, Blu-ray, flash storage and the like. The audio data stream can be part of the media by mixing with existing audio in the media or by adding an additional audio layer to the media. The audio data stream contains the identifier to identify the media. In an embodiment of the present invention, the identifier is a set of audio frequencies. The audio frequencies are preferably in one of ultrasonic range or infrasonic range. In an embodiment, the audio data stream is in a human inaudible frequency range. Examples of the media include, but are not limited to, a TV show, a video advertisement, radio show, an audio advertisement, a movie and a sports telecast. Examples of the one or more electronic devices include, but are not limited to, TV, radio, computer, laptop, cinema, mobile and PDA.

Further, the reception module 104 receives the audio data stream on at least one communication device. Examples of the at least one communication device include, but are not limited to, a mobile phone, a tablet, a computing device, a wearable and a PDA. The audio data stream is received via one or more microphones present on the at least one communication device.

Further, the decipher module 106 deciphers the identifier from the audio data stream. In an embodiment of the present invention, deciphering the identifier includes a FFT (Fast Fourier Transform) module. The FFT module converts audio data stream into frequencies using FFT, from which the identifier is deciphered. In another embodiment, one or more techniques can be used for extracting frequencies from the audio data stream. Examples of the one or more techniques include, but are not limited to, Fourier Transform, McAulay-Quatieri (MQ) analysis, short term Fourier transform, High-pass filter, Low-pass filter and MEL frequency filter bank.

Further, the server reception module 108 receives the identifier & device data at a server, where the device data includes device information of the at least one communication device. In an embodiment of the present invention, the device data includes a device identifier. Examples of the device identifier includes, but are not limited to, a device ID, IMEI number, Android ID, Apple ID, IDFA (Advertising Identifier), AID (Advertising Identifier), UDID (Unique Device Identifier), mobile number and MAC ID. In an embodiment of the present invention, the device data includes user agent, device model, device manufacturer, cellular service provider, browser, installed applications and location. In an embodiment of the present invention, the identifier and the device data are received via Internet. In another embodiment of the present invention, the identifier is received via SMS. The server then associates and stores the identifier in the audio data stream and the device identifier.

Finally, the marketing module 110 sends one or more messages to the at least one communication device, where the one or more messages is related to the identifier. Examples of the one or more messages include, but are not limited to, one or more of advertisements, push notifications, emails and SMS.

In an embodiment of the present invention, the one or more messages are sent via one or more real-time bidding ad exchanges. The server received an ad request from the one or more real-time bidding ad exchanges. The ad request contains device identifiers of the communication devices from which the ad request is generated. The server checks if a device identifier matches the device identifier of the at least one communication device. On finding a match, the server bids for the ad request, by sending a bid response. On winning the bid, the server sends an advertisement to the at least one communication device, where the advertisement is related to the identifier of the audio data stream.

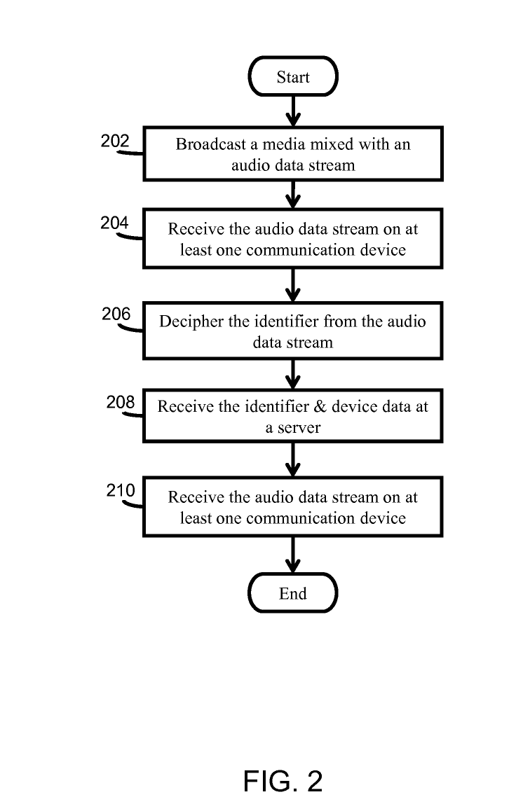

FIG. 2 shows a flow chart of a method for cross-device targeting of users, in accordance with an embodiment of the present invention. At step 202, the system 100 broadcasts a media mixed with an audio data stream to one or more electronic devices, where the audio data stream contains an identifier. The audio data stream is in human inaudible frequency range. In an embodiment of the present invention, t the audio data stream is in one of ultrasonic audio range and infrasonic frequency range. Examples of the one or more electronic devices include, but are not limited to, one or more of TV, radio, music player, stored media player, and Internet connected device. In an embodiment, the media format is one of an audio format and an audio-video formats.

Further, at step 204, the system 102 receives the audio data stream on at least one communication device. Further, at step 206, the system 100 deciphers the identifier from the audio data stream. In an embodiment of the present invention, deciphering includes performing FFT (Fast Fourier Transform) on the media.

Further, at step 208, the system 100 receives the identifier & device data at a server, where the device data includes device information of the at least one communication device. In an embodiment, the system 100 received the identifier and the device data via one of Internet and SMS. Examples of the device data include, but are not limited to, at least one of a device ID, IMEI number, Android ID, Apple ID, IDFA (Advertising Identifier), AID (Advertising Identifier), UDID (Unique Device Identifier), mobile number and MAC ID.

Finally, at step 210, the system 100 sends one or more messages to the at least one communication device, where the one or more messages is related to the identifier. The one or more messages include one or more of advertisements, push notifications, emails and SMS. In an embodiment, the one or more messages are sent via one or more real-time bidding ad exchanges.

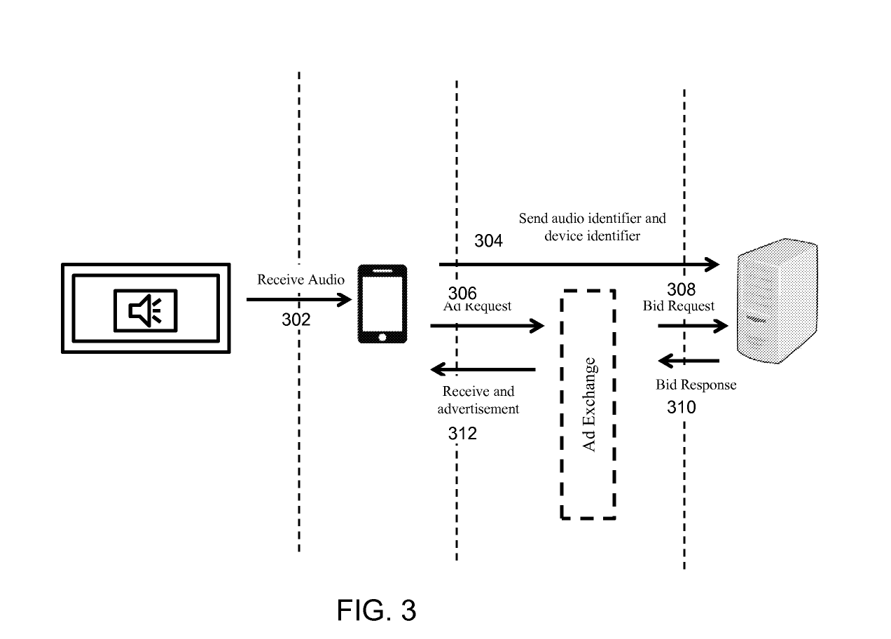

FIG. 3 shows a method for the implementation of the present invention, in accordance with an embodiment of the present invention. At step 302, a communication device receives audio from a TV. The audio is received on the communication device by a code present on the registered mobile device. In an embodiment of the present invention, the code runs in the background. In another embodiment of the present invention, the user for receiving the audio activates the code. The audio includes an audio identifier, where the audio identifier is a unique identifier for a TV advertisement playing on the TV. The communication device then deciphers the audio identifier from the audio, and then sends the audio identifier along with its device ID to a server at step 304. In an embodiment of the present invention, the audio identifier and the device identifier are sent via Internet. In another embodiment of the present invention, the audio identifier is sent from the communication device via SMS. Futher, the server then stores the audio identifier and the device ID in a database. Further, a user then browses an application on the communication device. The application includes an advertisement slot. The communication device then sends a request to an ad exchange for an ad at step 306. The ad exchange then sends a bid request for the ad slot to a plurality of servers at step 308. The server then checks if the device ID in the bid request is same as the stored device ID. On finding the match, the server then sends a bid response at step 310. Finally at step 312, an ad is displayed on the communication device, where the ad is similar to the TV advertisement.

In one embodiment of the present invention, the system for cross-device targeting of users uses acoustic waves as audio data stream. Preferably, acoustic signals in the infrasonic frequency band are used. In another embodiment of the present invention, acoustic signals in the ultrasonic frequency band are used. In one embodiment of the present invention, acoustic waves in the infrasonic frequency range will be used. Infrasonic is in the frequency range that is lower than 20 Hz, and typically lower. In the preferred embodiment, the frequency range of 15-20 Hz has been selected for the infrasonic acoustic signals.

In another embodiment of the present invention, the frequency range of 17-20 KHz has been selected for the ultrasonic acoustic signals. In particular, one embodiment uses 17.5 kHz for one FSK frequency and 18.5 kHz for the other FSK frequency. These numbers were selected because half (for Nyquist sampling) of the 44.1 KHz recording rate for CD-quality audio is 22.05 KHz. The upper limit of 20 KHz is selected because in most sound systems, sound above 20 KHz is filtered out sharply. Thus, this embodiment uses sounds in the frequency range that can be supported by the current sound systems that are installed in today's media devices like TV, audio speakers and computer sound systems.

Infrasonic or ultrasonic frequency ranges have certain benefits over the audible frequency range. First, most people cannot hear infrasonic or ultrasonic sounds. Second, infrasonic or ultrasonic sounds are less subject to interference. Most ambient noise is audible and audible sounds are omnidirectional. Thus, using audible frequencies would subject the detection to all sorts of unwanted interference. As the sound is at a lower or higher frequency range (such as infrasonic), it also becomes more directional. Third, the infrasonic or ultrasonic sound can be generated from existing devices. For example, the sound device (e.g., “Sound Blaster” sound card) in a personal computer supports the ultrasonic frequency band.

Basically, you can specify a range of frequencies to use, and an alphabet of characters that can be transmitted. The frequency spectrum is split into ranges corresponding to the specified alphabet and start/end codes, with each character/code corresponding to a part of the full frequency range

The sending side converts each character of the word to be sent into the center of the corresponding frequency range, and transmits that frequency for certain duration. The receiving side does a continuous Fourier transform of the signal and looks for peaks in the specified frequency range. Upon finding a peak for a significant duration, it does the conversion back from frequency to character. This is essentially a single-tone multi-frequency signaling (STMF) scheme.

In an embodiment of the present invention, the human inaudible sound is sent along with an advertisement getting played on Television, on Radio or any other communication device. The human inaudible sound is deciphered by one or more communication devices of one or more users listening to the advertisement. The one or more communication device then sends that information to the server. The server can then send ads to be displayed on the one or more communication device. In another embodiment of the present invention, the server sends ads to the one or more communication device through other advertisement ad networks.

The computer program product of the invention is executable on a computer system for causing the computer system to perform a method for identifying a unique user across multiple communication devices of the present invention. The computer system includes a microprocessor, an input device, a display unit and an interface to the Internet. The microprocessor is connected to a communication bus. The computer also includes a memory. The memory may include Random Access Memory (RAM) and Read Only Memory (ROM). The computer system further comprises a storage device. The storage device can be a hard disk drive or a removable storage drive such as a floppy disk drive, optical disk drive, etc. The storage device can also be other similar means for loading computer programs or other instructions into the computer system. The computer system also includes a communication unit. The communication unit allows the computer to connect to other databases and the Internet through an I/O interface. The communication unit allows the transfer as well as reception of data from other databases. The communication unit may include a modem, an Ethernet card, or any similar device which enables the computer system to connect to databases and networks such as LAN, MAN, WAN, Wireless, GPRS, Ultrawide band and the Internet. The computer system facilitates inputs from a user through input device, accessible to the system through I/O interface.

The computer system executes a set of instructions that are stored in one or more storage elements, in order to process input data. The set of instructions may be a program instruction means. The storage elements may also hold data or other information as desired. The storage element may be in the form of an information source or a physical memory element present in the processing machine.

The set of instructions may include various commands that instruct the processing machine to perform specific tasks such as the steps that constitute the method of the present invention. The set of instructions may be in the form of a software program. Further, the software may be in the form of a collection of separate programs, a program module with a larger program or a portion of a program module, as in the present invention. The software may also include modular programming in the form of object-oriented programming. The processing of input data by the processing machine may be in response to user commands, results of previous processing or a request made by another processing machine.

While the present invention has been described in connection with preferred embodiments, it will be understood by those skilled in the art that variations and modifications of the preferred embodiments described above may be made without departing from the scope of the invention. Other embodiments will be apparent to those skilled in the art from a consideration of the specification or from a practice of the invention disclosed herein. It is intended that the specification and the described examples are considered exemplary only, with the true scope of the invention indicated by the following claims.

1. A method for retargeting a user across multiple devices, the method comprising:
a. broadcasting a media mixed with an audio data stream to one or more electronic devices, the audio data stream containing an identifier;
b. receiving the audio data stream on at least one communication device;
c. deciphering the identifier from the audio data stream;
d. receiving the identifier & device data at a server, the device data including device information of the at least one communication device; and,
e. sending one or more messages to the at least one communication device, the one or more messages being related to the identifier.

2. The method as recited in claim 1, wherein the audio data stream is in human inaudible frequency range.

3. The method as recited in claim 1, wherein the audio data stream is in one of ultrasonic audio range and infrasonic frequency range.

4. The method as recited in claim 1, wherein the one or more electronic devices include one or more of TV, radio, music player, stored media player, and Internet connected device.

5. The method as recited in claim 1, wherein the media format is one of an audio format and an audio-video formats.

6. The method as recited in claim 1, wherein deciphering the identifier comprises performing FFT (Fast Fourier Transform) on the media.

7. The method as recited in claim 1, wherein the device data includes at least one of a device ID, IMEI number, Android ID, Apple ID, IDFA (Advertising Identifier), AID (Advertising Identifier), UDID (Unique Device Identifier), mobile number and MAC ID.

8. The method as recited in claim 1, wherein sending the one or more messages comprises sending via one or more of advertisements, push notifications, emails and SMS.

9. The method as recited in claim 1, wherein the one or more messages are sent via one or more real-time bidding ad exchanges.

10. The method as recited in claim 1, wherein receiving the identifier and the device data at the server comprises receiving via one of Internet and SMS.

11. A system for retargeting a user across multiple devices, the system comprising:
f. a broadcast module, the broadcast module broadcasting a media mixed with an audio data stream to one or more electronic devices, the audio data stream containing an identifier;
g. a reception module, the reception module receiving the audio data stream on at least one communication device;
h. a decipher module, the decipher module deciphering the identifier from the audio data stream;
i. a server reception module, the server reception module receiving the identifier & device data to a server, the device data including device information of the at least one communication device; and,
j. a marketing module, the marketing module sending one or more messages to the at least one communication device, the one or more messages being related to the identifier.

12. The system as recited in claim 11, wherein the audio data stream is in human inaudible frequency range.

13. The system as recited in claim 11, wherein the audio data stream is in one of ultrasonic audio range and infrasonic frequency range.

14. The system as recited in claim 11, wherein the one or more electronic devices include one or more of TV, radio, music player, stored media player, and Internet connected device.

15. The system as recited in claim 11, wherein the media format is one of an audio format and an audio-video formats.

16. The system as recited in claim 11, wherein the decipher module comprises a FFT module, the FFT module performing FFT (Fast Fourier Transform) on the media.

17. The system as recited in claim 11, wherein the device data includes at least one of a device ID, IMEI number, Android ID, Apple ID, IDFA (Advertising Identifier), AID (Advertising Identifier), UDID (Unique Device Identifier), mobile number and MAC ID.

18. The system as recited in claim 11, wherein the marketing module sends the one or more messages via one or more of advertisements, push notifications, emails and SMS.

19. The system as recited in claim 11, wherein the one or more messages are sent via one or more real-time bidding ad exchanges.

20. The system as recited in claim 11, wherein the server reception module receiving the identifier and the device data via one of Internet and SMS.

21. A computer program product for retargeting a user across multiple devices, the computer program product comprising a non-transitory computer-readable medium having instructions embodied thereon, which when executed by a computer cause the computer to implement a method, the method comprising:
k. broadcasting a media mixed with an audio data stream to one or more electronic devices, the audio data stream containing an identifier;
l. receiving the audio data stream on at least one communication device;
m. deciphering the identifier from the audio data stream;
n. receiving the identifier & device data at a server, the device data including device information of the at least one communication device; and,
o. sending one or more messages to the at least one communication device, the one or more messages being related to the identifier.
